(19) United States
(12) Patent Application Publication
(10) Pub. No.: US 2003/0030179 A1
(43) Pub. Date: Feb. 13, 2003

(54) Nozzle for injection molding and injection molding machine

(76) Inventors: Satoshi Kajikawa, Numazu-shi (JP); Tadayoshi Gotoh, Numazu-shi (JP)

Correspondence Address: PILLSBURY WINTHROP, LLP, P.O. BOX 10500, MCLEAN, VA, 22102, US

(21) Appl. No.: 10/210,071

(22) Filed: Aug. 2, 2002

(30) Foreign Application Priority Data
Aug. 10, 2001 (JP) 2001-244605

(51) Int. Cl. B29C 45/16; B29C 45/23

(52) U.S. Cl. 264/255; 425/573; 425/130; 425/564; 264/328.8

(57) ABSTRACT

The nozzle is constituted by a nozzle body and a connecting block. The nozzle body is constituted by a casing and a core. A first passage is formed in the center of the core and a second passage is formed between the external surface of the core and the internal surface of the casing. The first passage and the second passage join together in front of the core and then lead to a discharge port at the tip end of the casing. In the interior of the connecting block are formed a first supply line and a second supply line. The first supply line connects a sub injection unit to a first supply port, and a first stop valve is provided within the line. The second supply line connects a main injection unit to a second supply port, and a second stop valve is provided within the line.

### CROSS-REFERENCE TO RELATED APPLICATIONS

This application is based upon and claims the benefit of priority from the prior Japanese Patent Application No. 2001-244605, filed Aug. 10, 2001, the entire contents of which are incorporated herein by reference.

### BACKGROUND OF THE INVENTION

1. Field of the Invention

The present invention relates to a nozzle for injection molding and, particularly, to the structure of a nozzle used in what is called sandwich molding which involves using two types of resins and forming a skin layer from one resin and a core layer from the other resin.

2. Description of the Related Art

FIG. 9 shows an outline of the construction of a conventional nozzle used in sandwich molding. This nozzle is constituted by a nozzle body 80 and a first needle valve 81 and a second needle valve 82, which are doubly built into the interior of the nozzle body. A discharge port 83 is provided at the tip end of the nozzle body 80. The tip end of the nozzle body 80 is connected to a gate 21 provided on the back surface of dies 20. The first needle valve 81 is built into the interior of the second needle valve 82, and a discharge port 84 is provided at the tip end of the second needle valve 82.

Between the external surface of the first needle valve 81 and the internal surface of the second needle valve 82 is formed a first passage 85. Similarly, between the external surface of the second needle valve 82 and the internal surface of the nozzle body 80 is formed a second passage 86. On the side surfaces near the tail end of the nozzle body 80 are provided a first supply port 87 and a second supply port 88, both to introduce molten resin. The first supply port 87 is connected to the discharge port 83 through a through hole 89 provided on the side surface of the second needle valve 82, the first passage 85 and the discharge port 84. The second supply port 88 is connected to the discharge port 83 through the second passage 86. A sub injection unit 91 is connected to the first supply port 87, and a main injection unit 92 is connected to the second supply port 88.

The opening and closing operation of the first passage 85 is performed before the discharge port 84 by axially moving the first needle valve 81 in the second needle valve 82. Similarly, the opening and closing operation of the second passage 86 is performed before the discharge port 83 by axially moving the second needle valve 82 within the nozzle body 80.

When sandwich molding is performed, the resin for the skin is supplied from the main injection unit 92, passes through the second supply port 88 and second passage 86 in this order, and is injected from the discharge port 83 into the dies 20. On the other hand, the resin for the core is supplied from the sub injection unit 91, passes through the first supply port 87, through hole 89, first passage 85 and discharge port 84 in this order, and is injected from the discharge port 83 into the dies 20.

The conventional nozzle used in sandwich molding was configured by doubly building the needle valves in the interior of the nozzle body as described above and hence had a complicated construction. For this reason, it took high cost to fabricate the nozzle.

### BRIEF SUMMARY OF THE INVENTION

The invention was made in order to solve the problem with the conventional nozzle for sandwich molding. The object of the invention is to provide a nozzle for sandwich molding, which has a simple construction in comparison with the conventional nozzle.

A nozzle for injection molding of the present invention comprises: a nozzle body being connected via a discharge port provided at the tip end thereof to the back surface of dies, and having a first supply port and a second supply port, a first passage which connects the first supply port to the discharge port and a second passage which connects the second supply port to the discharge port being formed in the interior of the nozzle body; a first supply line introducing a first molten resin to the first supply port; a first stop valve being provided within the first supply line; a second supply line introducing a second molten resin to the second supply port; and a second stop valve being provided within the second supply line.

According to a nozzle for injection molding of the present invention, a first molten resin (for example, a resin for the core) is introduced into the nozzle body through the first stop valve, first supply line and first supply port, passes through the first passage, and is injected into the dies from the discharge port. In contrast to this, a second molten resin (for example, a resin for the skin) is introduced into the nozzle body through the second stop valve, second supply line and second supply port, passes through the second passage, and is injected into the dies from the discharge port. Sandwich molding can be performed by appropriately adjusting the supply timing of the first molten resin and second molten resin.

In a nozzle for injection molding of the present invention, the first stop valve and second stop valve are provided respectively within the first supply line and second supply line which are provided outside the nozzle body. Therefore, the types of molten resins injected from the nozzle body into the dies can be switched by using the first stop valve and second stop valve disposed outside the nozzle body and hence the construction of the interior of the nozzle body can be simplified in comparison with the conventional nozzle.

Preferably, the first passage is formed as a passage in the shape of a through hole on the center axis of the nozzle body and the second passage is formed as an annular passage around the first passage. The first passage and the second passage join together before the discharge port.

Preferably, the nozzle body is constituted by a casing and a core built into the casing. In this case, the discharge port is formed at the tip end of the casing and the first passage is formed on the center axis of the core. The second passage is formed between the external surface of the core and the internal surface of the casing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of the invention.

FIG. 1 is a view of an example of a nozzle for injection molding according to the present invention.

FIG. 2 is an explanatory diagram of an example of the injection process of sandwich molding.

FIG. 3 is an explanatory diagram of another example of the injection process of sandwich molding.

FIG. 4A is an explanatory diagram of an example of the condition of the flow of molten resin when a nozzle according to the invention is used.

FIG. 4B is an explanatory diagram of an example of the condition of the flow of molten resin when a nozzle according to the invention is used.

FIG. 4C is an explanatory diagram of an example of the condition of the flow of molten resin when a nozzle according to the invention is used.

FIG. 5A is an explanatory diagram of another example of the condition of the flow of molten resin when a nozzle according to the invention is used.

FIG. 5B is an explanatory diagram of another example of the condition of the flow of molten resin when a nozzle according to the invention is used.

FIG. 5C is an explanatory diagram of another example of the condition of the flow of molten resin when a nozzle according to the invention is used.

FIG. 5D is an explanatory diagram of another example of the condition of the flow of molten resin when a nozzle according to the invention is used.

FIG. 6A is an explanatory diagram of another example of the condition of the flow of molten resin when a nozzle according to the invention is used.

FIG. 6B is an explanatory diagram of another example of the condition of the flow of molten resin when a nozzle according to the invention is used.

FIG. 6C is an explanatory diagram of another example of the condition of the flow of molten resin when a nozzle according to the invention is used.

FIG. 7 is a view of another example of a nozzle for injection molding according to the present invention.

FIG. 8 is a view of another example of a nozzle for injection molding according to the present invention.

FIG. 9 is a view of an example of a conventional nozzle for injection molding.

### DETAILED DESCRIPTION OF THE INVENTION

Embodiment 1

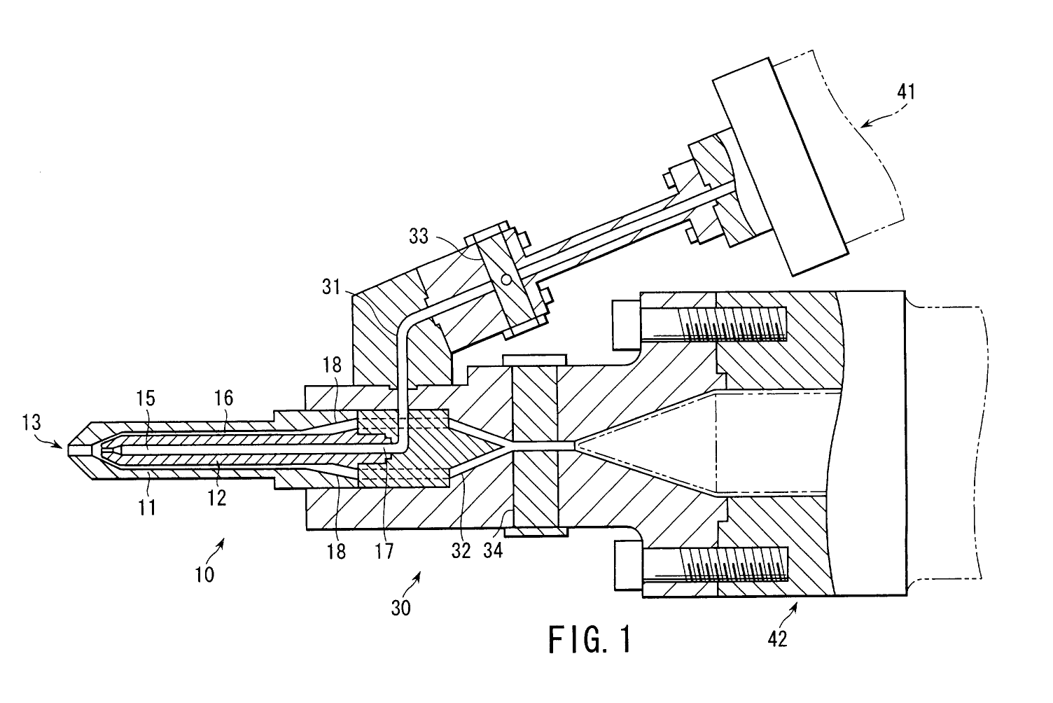

FIG. 1 shows an example of a nozzle for injection molding based on the present invention. In the figure, the numeral 10 indicates a nozzle body; the numeral 11, a casing; the numeral 12, a core; the numeral 13, a discharge port; the numeral 15, a first passage; the numeral 16, a second passage; the numeral 17, a first supply port; the numeral 18, a second supply port; the numeral 31, a first supply line; the numeral 32, a second supply line; the numeral 33, a first stop valve; and the numeral 34, a second stop valve.

This nozzle for injection molding is constituted by the nozzle body 10 and a connecting block 30. To the connecting block 30 are connected a main injection unit 42 and a sub injection unit 41, as will be described below.

The nozzle body 10 is constituted by the casing 11 and the core 12 which is built into the interior of the casing. At the tip end of the casing 11 is provided the discharge port 13. The tip end of the casing 11 is connected to a gate provided on the back surface of dies (not shown). The tail end of the casing 11 is fixed to the connecting block 30.

At the center of the core 12 is axially formed a through hole 15 (hereinafter referred to as the first passage). Between the external surface of the core 12 and the internal surface of the casing 11 is formed an annular passage 16 (hereinafter referred to as the second passage). The first passage 15 and the second passage 16 join together in front of the core 12 and then lead to the discharge port 13. On the tail end surface of the core 12 is provided the first supply port 17 to introduce a first molten resin. On the tail end surface of the casing 11 is provided the second supply port 18 to introduce a second molten resin. The first supply port 17 is connected to the discharge port 13 through the first passage 15. The second supply port 18 is connected to the discharge port 13 through the second passage 16.

In the interior of the connecting block 30 are formed the first supply line 31 and the second supply line 32. The first supply line 31 is connected to the sub injection unit 41 on the upstream side and to the first supply port 17 on the downstream side. Within the first supply line 31 is provided the first stop valve 33, which is a rotary shut-off valve. The second supply line 32 is connected to the main injection unit 42 on the upstream side and to the second supply port 18 on the downstream side. Within the second supply line 32 is provided the second stop valve 34, which is a rotary shut-off valve.

By operating the first stop valve 33 and second stop valve 34, the type of molten resin supplied to the interior of the nozzle body 10 is switched between the first molten resin and the second molten resin. Furthermore, it is also possible to simultaneously supply the two types of resin to the interior of the nozzle body 10.

When sandwich molding is performed, usually the resin for the skin is supplied from the main injection unit 42, passes through the second stop valve 34, second supply line 32, second supply port 18 and second passage 16 in this order, and is injected from the discharge port 13 into the dies. On the other hand, the resin for the core is supplied from the sub injection unit 41, passes through the first stop valve 33, first supply line 31, first supply port 17 and first passage 15 in this order, and is injected from the discharge port 13 into the dies.

Next, the process of sandwich molding in the injection molding machine will be described below.

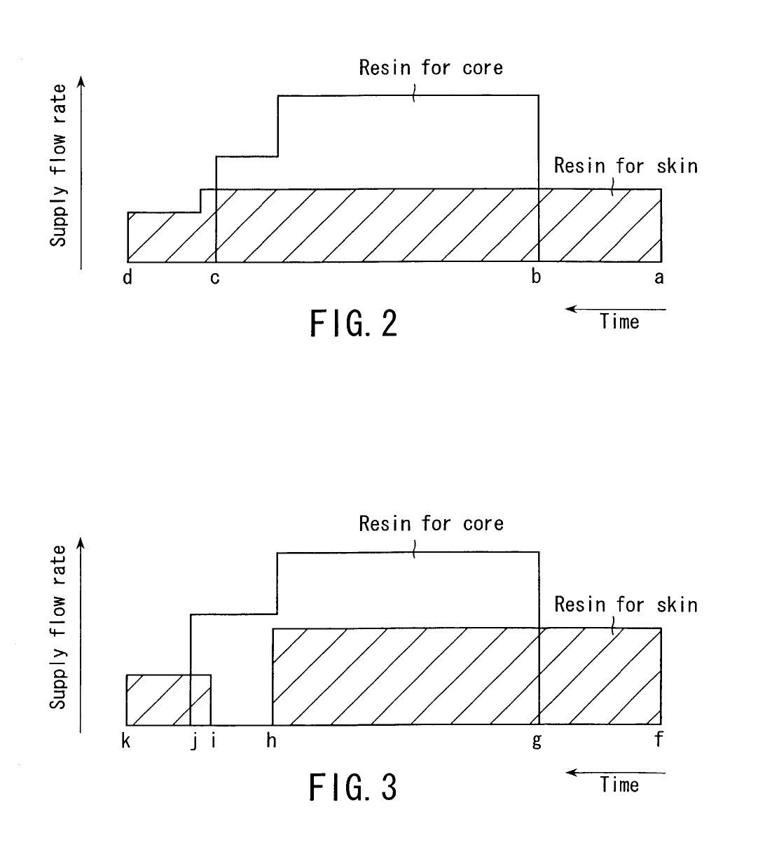

FIGS. 2 and 3 show examples of the process of sandwich molding. In the figures, the ordinate indicates the molten resin supply rate and the abscissa indicates time.

In the example shown in FIG. 2, the resin for the skin is continuously injected into the dies from point a (start point of injection) to point d (finish point of injection). For the resin for the core, the injection is started at point b a little while after the start of the injection of the resin for the skin and the injection is finished at point c a little while before the finish of the injection of the resin for the skin.

In the example shown in FIG. 3, the resin for the skin is injected for a period from point f (start point of injection) to point h, and the injection is started again at point i after the interruption of the injection at point h and finished at point k (finish point of injection). For the resin for the core, the injection is started at point g a little while after the start of injection of the resin for the skin and finished at point j a little while before the finish of injection of the resin for the skin.

In the case of the process shown in FIG. 2, what is important for the control of the molding process resides in the following points:

(i) the filling ratio of the resin for the core is determined by where to set points b and c between points a and d;

(ii) the amount of resin for the skin injected between points a and b determines whether the resin for the core is formed without bursting through a skin layer; and

(iii) it is ensured that the resin for the skin injected between points c and d completely replaces the molten resin near the discharge port of the nozzle, whereby only the resin for the skin is injected first at the beginning of the next molding cycle.

Similarly, in the case of the process shown in FIG. 3, what is important for the control of the molding process resides in the following points:

(i) the filling ratio of the resin for the core is determined by where to set points g and j;

(ii) the amount of resin for the skin injected between points f and g determines whether the resin for the core is formed without bursting through a skin layer; and

(iii) the amount of resin for the skin injected between points j and k determines whether the resin near the discharge port of the nozzle is completely replaced by the resin for the skin.

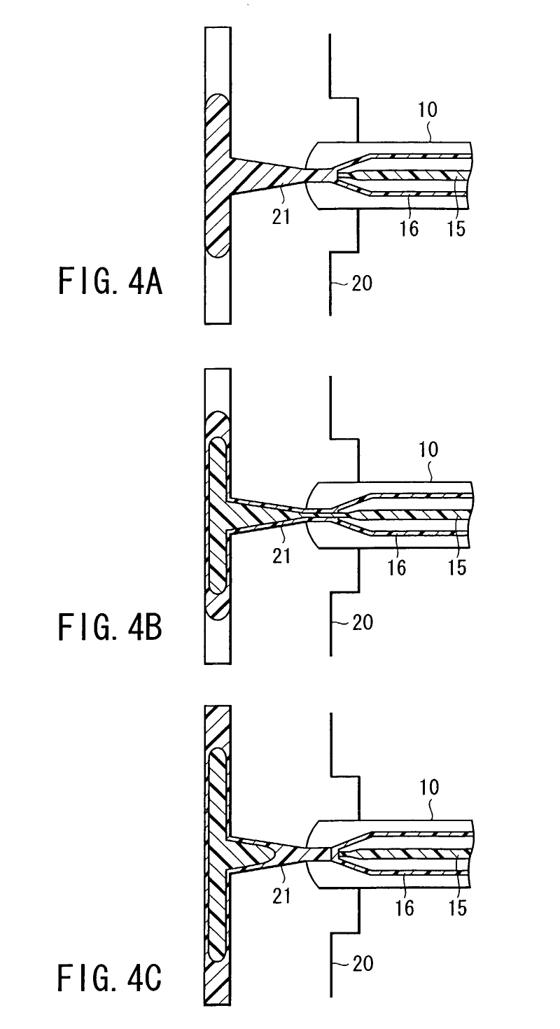

The flow of molten resin when sandwich molding is performed by use of the nozzle shown in FIG. 1 by the process shown in FIG. 2 will be described below by referring to FIGS. 4A to 4C. Incidentally, in this example the main injection unit 42 is used to supply the resin for the skin and the sub injection unit 41 is used to supply the resin for the core.

First, when the second stop valve 34 is opened with the first stop valve 33 kept in a closed condition, the resin for the skin is injected into the dies 20 from the main injection unit 42 through the second supply line 32 and second passage 16 (point a in FIG. 2). As a result of this operation, as shown in FIG. 4A, only the resin for the skin flows into the molds 20.

Next, when the first stop valve 33 is opened with the second stop valve 34 kept in an open condition, the resin for the core begins to be injected into the dies 20 from the sub injection unit 41 through the first supply line 31 and first passage 15 (point b in FIG. 2). As a result of this operation, as shown in FIG. 4B, the resin for the core flows into the dies 20 from the center portion thereof and, at the same time, the resin for the skin flows into the dies 20 from the peripheral portion thereof. Within the dies 20, the resin for the skin that has flowed in first comes into contact with the dies 20 and is rapidly cooled, forming a skin layer from the gate 21 along the die surface. For this reason, the resin for the core that has flowed in later flows into the center portion of the dies that still maintains a molten state. In this manner, a sandwich structure is formed.

Next, when the first stop valve 33 is closed (point c in FIG. 2), as shown in FIG. 4C, the resin for the skin is resupplied from the main injection unit 41 to the interior of the dies 20 and the whole of the resin for the core which has been injected first is covered by the resin for the skin.

Lastly, sandwich molding is finished by closing the second stop valve 34 (point d in FIG. 2) .

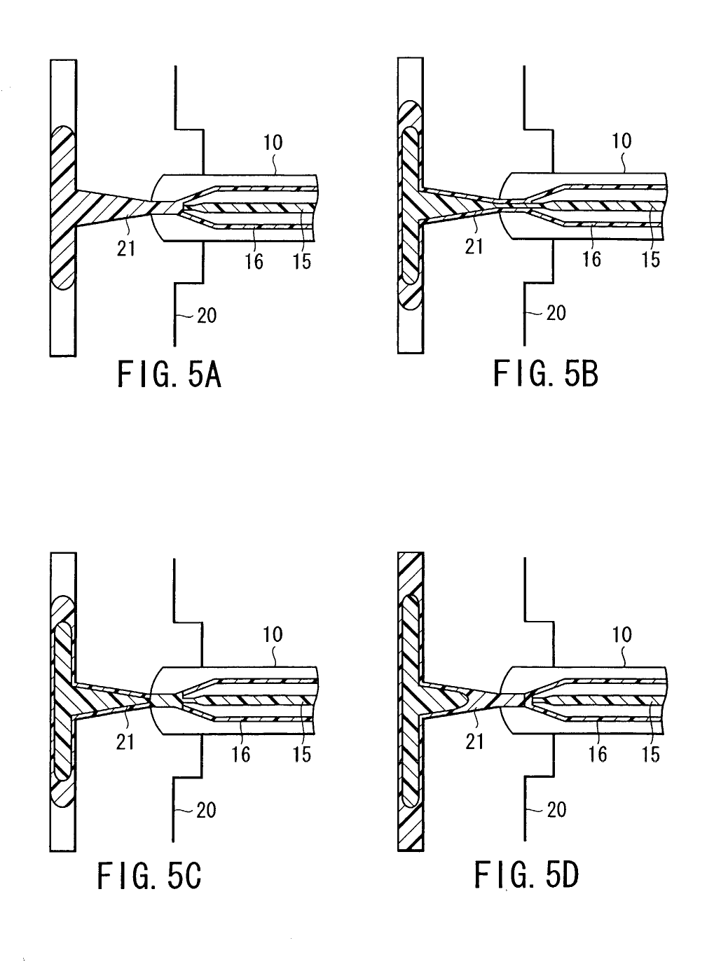

The flow of molten resin when sandwich molding is performed by use of the nozzle shown in FIG. 1 by the process shown in FIG. 3 will be described below by referring to FIGS. 5A to 5D. Incidentally, also in this example, the main injection unit 42 is used to supply the resin for the skin and the sub injection unit 41 is used to supply the resin for the core.

First, when the second stop valve 34 is opened with the first stop valve 33 kept in a closed condition, the resin for the skin is injected into the dies 20 from the main injection unit 42 through the second supply line 32 and second passage 16 (point f in FIG. 3). As a result of this operation, as shown in FIG. 5A, only the resin for the skin flows into the molds 20.

Next, when the first stop valve 33 is opened with the second stop valve 34 kept in an open condition, the resin for the core begins to be injected into the dies 20 from the sub injection unit 41 through the first supply line 31 and first passage 15 (point g in FIG. 3). As a result of this operation, as shown in FIG. 5B, the resin for the core flows into the dies 20 from the center portion thereof and, at the same time, the resin for the skin flows into the dies 20 from the peripheral portion thereof.

Next, the injection of the resin for the skin is temporarily suspended and only the resin for the core is injected into the dies 20 (point h in FIG. 3). Also when the injection of the resin for the skin is thus temporarily suspended while the resin for the core is being injected, the resin for the core flows into the center portion of the dies that still maintains a molten state as shown in FIG. 5C if a sufficient amount of resin for the skin is stored in the dies 20 beforehand and if a skin layer of sufficient thickness is formed in the gate 21 of the dies.

Next, the injection of the resin for the skin is restarted (point i in FIG. 3) just before the injection of the resin for the core is finished (point j in FIG. 3). As a result of this operation, as shown in FIG. 5D, the resin for the skin is resupplied to the interior of the dies 20 and the whole of the resin for the core which has been injected first is covered by the resin for the skin.

Lastly, sandwich molding is finished by closing the second stop valve 34 (point k in FIG. 3).

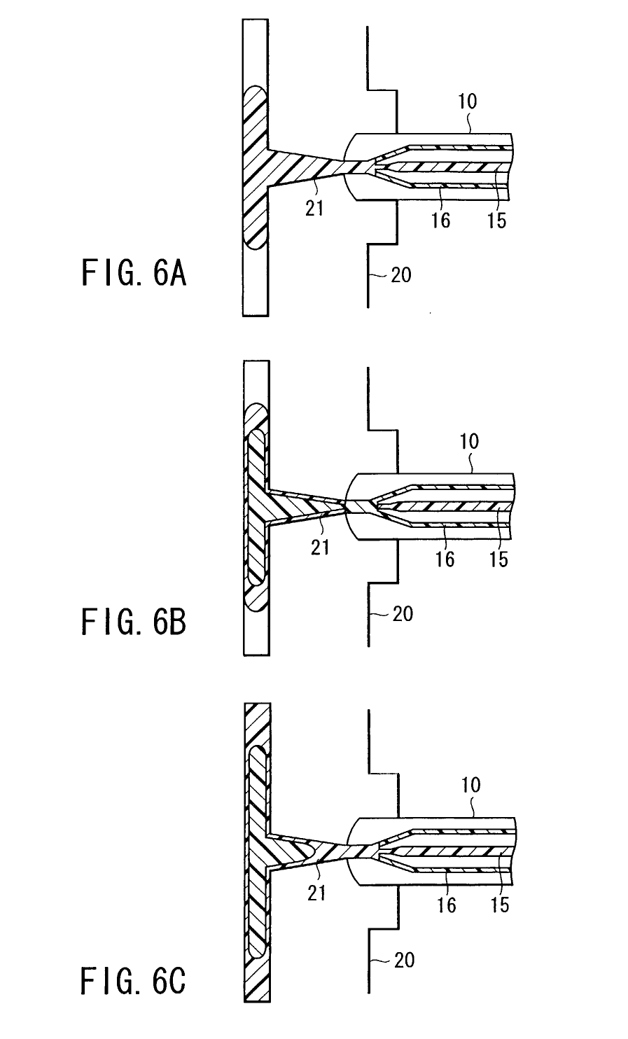

FIGS. 6A to 6C show another example of the molding process performed by use of the nozzle shown in FIG. 1. In this example, the roles of the main injection unit 42 and sub injection unit 41 are mutually changed from those described in the above-descried examples (FIGS. 4A to 4C and FIGS. 5A to 5D). That is, the main injection unit 42 is used to supply the resin for the core and the sub injection unit 41 is used to supply the resin for the skin.

First, when the first stop valve 33 is opened with the second stop valve 34 kept in a closed condition, the resin for the skin is injected into the dies 20 from the sub injection unit 41 through the first supply line 31 and first passage 15. As a result of this operation, as shown in FIG. 6A, only the resin for the skin flows into the dies 20.

Next, when the first stop valve 33 is closed and the second stop valve 34 is opened, the resin for the core is injected into the dies 20 from the main injection unit 42 through the second supply line 32 and second passage 16. At this time, as described above, the resin for the core flows into the center portion of the dies that still maintains a molten state as shown in FIG. 6B if a sufficient amount of resin for the skin is stored in the dies 20 beforehand and if a skin layer of sufficient thickness is formed in the gate 21 of the dies.

Next, when the second stop valve 34 is closed and the first stop valve 33 is opened, as shown in FIG. 6C, the resin for the skin is resupplied to the interior of the dies 20 and the whole of the resin for the core which has been injected first is covered by the resin for the skin.

Lastly, sandwich molding is finished by closing the first stop valve 33.

As described above, by appropriately controlling the injection timing and injection amounts of the resin for the skin and the resin for the core into the dies, it is also possible to obtain products quite equivalent to those obtained by a conventional method by adopting a method the reverse of the conventional method, i.e., by injecting the resin for the skin from the inside and injecting the resin for the core from the outside of the resin for the skin.

As described above, when sandwich molding is performed by use of the nozzle shown in FIG. 1, it is possible to use either the main injection unit 42 or the sub injection unit 41 to inject the resin for the skin and use the other to inject the resin for the core, because both the main injection unit 42 and the sub injection unit 41 are connected to the nozzle body 10 through the stop valves 34, 33.

Embodiment 2

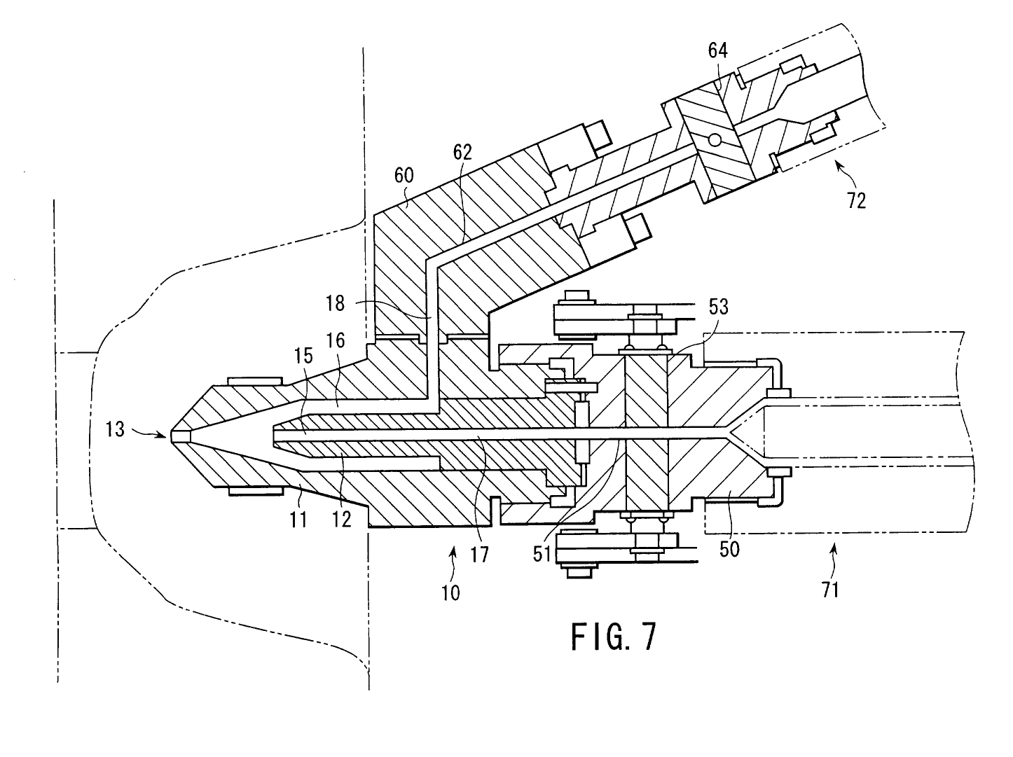

FIG. 7 shows another example of a nozzle for injection molding based on the present invention.

In this example, in contrast to the above-described example (FIG. 1) as will be described below, a passage (a first passage 15) in the center portion of the nozzle is connected to a main injection unit 71, and an annular passage (a second passage 16) surrounding the first passage 15 is connected to a sub injection unit 72. By this arrangement, the construction of the nozzle can be further simplified in comparison with the example shown in FIG. 1.

This nozzle for injection molding is constituted by a nozzle body 10, a first connecting block 50 and a second connecting block 60. The nozzle body 10 is constituted by a casing 11 and a core 12 built into the interior of the casing. A discharge port 13 is provided at the tip end of the casing 11. The tip end of the casing 11 is connected to a gate 21 provided on the back surface of the dies 20.

At the center of the core 12 is axially formed a through hole 15 (a first passage). Between the external surface of the core 12 and the internal surface of the casing 11 is formed an annular passage 16 (a second passage). The first passage 15 and the second passage 16 join together in front of the core 12 and then lead to the discharge port 13.

On the tail end surface of the core 12 is provided a first supply port 17 to introduce a first molten resin. The first supply port 17 is connected to the discharge port 13 through the first passage 15. On the side surface of the casing 11 is provided a second supply port 18 to introduce a second molten resin. The second supply port 18 is connected to the discharge port 13 through the second passage 16.

The core 12 is connected, at the tail end surface thereof, to the main injection unit 71 through the first connecting block 50. A first supply line 51 is formed in the interior of the first connecting block 50. The first supply line 51 is connected to the main injection unit 71 on the upstream side and to the first supply port 17 on the downstream side. Within the first supply line 51 is provided a first stop valve 53, which is a rotary shut-off valve.

Similarly, the casing 11 is connected, at the side surface thereof, to the sub injection unit 72 through the second connecting block 60. A second supply line 62 is formed in the interior of the second connecting block 60. The second supply line 62 is connected to the sub injection unit 72 on the upstream side and to the second supply port 18 on the downstream side. Within the second supply line 62 is provided a second stop valve 64, which is a rotary shut-off valve.

By operating the first stop valve 53 and second stop valve 64, the types of molten resin supplied to the interior of the nozzle body 10 can be switched between the first molten resin and the second molten resin. Furthermore, it is also possible to simultaneously supply the two types of resin to the interior of the nozzle body 10.

When sandwich molding is performed, usually the resin for the skin is supplied from the sub injection unit 72, passes through the second stop valve 64, second supply line 62, second supply port 18 and second passage 16 in this order, and is injected from the discharge port 13 into the dies 20. On the other hand, the resin for the core is supplied from the main injection unit 71, passes through the first stop valve 53, first supply line 51, first supply port 17 and first passage 15 in this order, and is injected from the discharge port 13 into the dies 20.

Incidentally, also in the nozzle shown in FIG. 7, as described in connection with FIG. 6, it is possible to cause the resin for the skin to be supplied from the main injection unit 72 and cause the resin for the core to be supplied from the sub injection unit 71 by reversing the supply of the resin for the skin and the resin for the core.

Embodiment 3

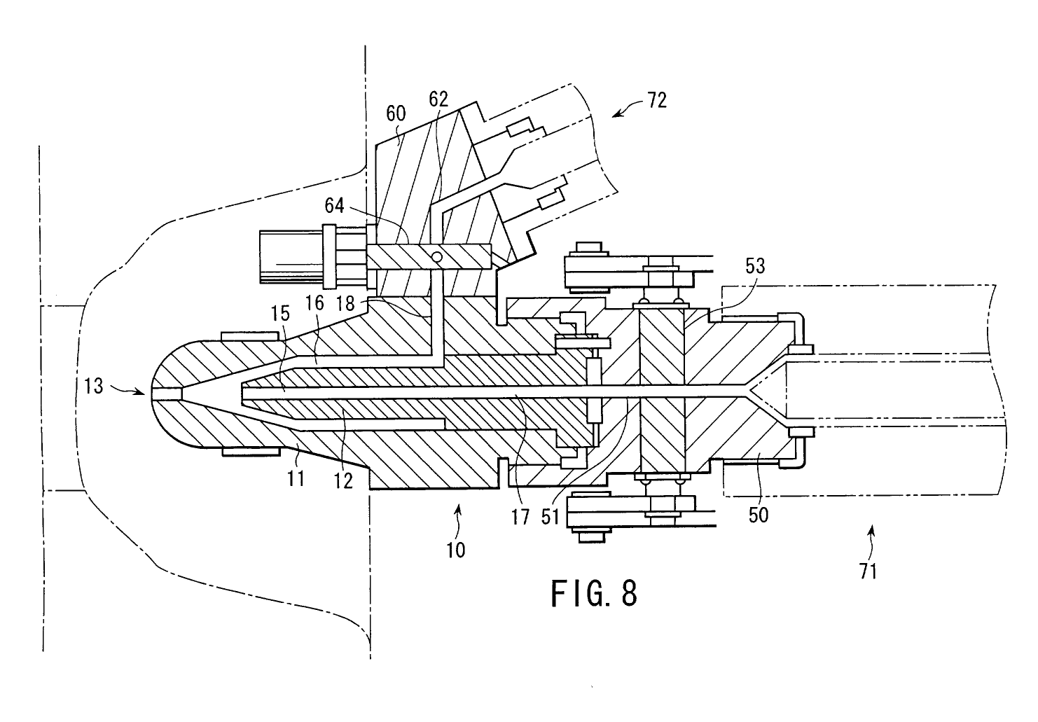

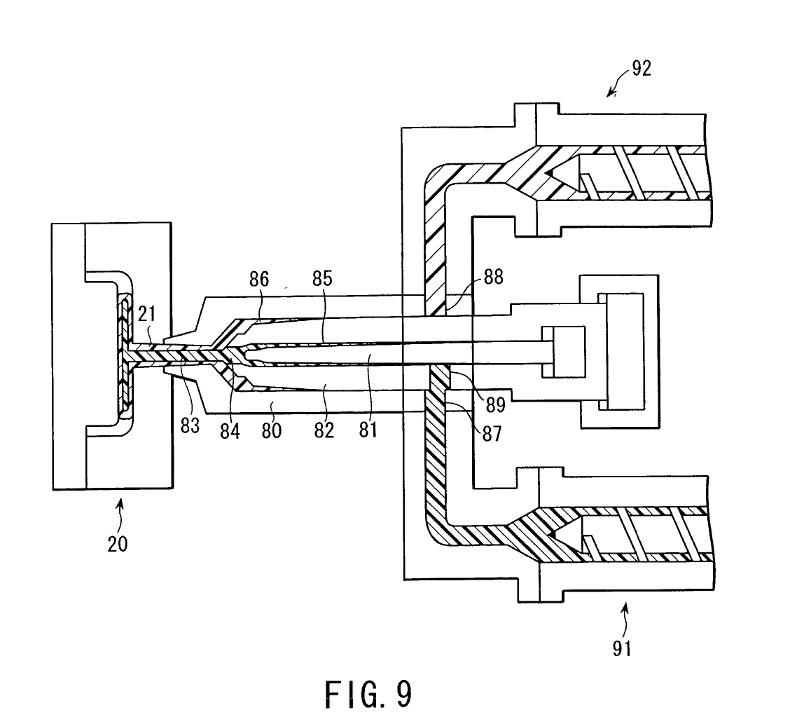

FIG. 8 shows an another example of a nozzle for injection molding based on the present invention.

In this example, the nozzle of the above-described example (FIG. 7) was partially modified and the second stop valve 64 provided within the second supply line 62 is disposed in close vicinity to a second supply port 18. As a result of this modification, the construction on the side of a sub injection unit 72 can be made more compact.

In the nozzles for injection molding of the present invention, the first supply line and second supply line are provided outside the nozzle body, and the first stop valve and second stop valve are provided, respectively, within the first supply line and second supply line. Therefore, the types of molten resin injected from the nozzle body into the dies can be switched by using the first stop valve and second stop valve disposed outside the nozzle body, and hence the construction of the interior of the nozzle body can be simplified in comparison with the conventional nozzle.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A nozzle for injection molding, comprising:
a nozzle body being connected via a discharge port provided at the tip end thereof to the back surface of dies, and having a first supply port and a second supply port, a first passage which connects the first supply port to the discharge port and a second passage which connects the second supply port to the discharge port being formed in the interior of said nozzle body;
a first supply line introducing a first molten resin to said first supply port;
a first stop valve being provided within the first supply line;
a second supply line introducing a second molten resin to said second supply port; and
a second stop valve being provided within the second supply line.

2. A nozzle for injection molding according to claim 1, wherein said first passage is a through hole formed on the center axis of said nozzle body, said second passage is an annular passage formed around said first passage, and said first passage and said second passage join together before said discharge port.

3. A nozzle for injection molding according to claim 2, wherein said nozzle body is constituted by a casing and a core built into the casing, said discharge port is formed at the tip end of said casing, said first passage is formed on the center axis of said core, and said second passage is formed between the external surface of said core and the internal surface of said casing.

4. An injection molding machine, comprising a nozzle for injection molding according to claim 1.

5. An injection molding machine, comprising a nozzle for injection molding according to claim 2.

6. An injection molding machine, comprising a nozzle for injection molding according to claim 3.

7. A process of sandwich molding for manufacturing an injection molding product, the surface portion of which is formed from a resin for skin and the interior of which is formed from a resin for core, by use of a nozzle,
said nozzle comprising:
a nozzle body being connected via a discharge port provided at the tip end thereof to the back surface of dies, and having a first supply port and a second supply port, a first passage which connects the first supply port to the discharge port and a second passage which connects the second supply port to the discharge port being formed in the interior of said nozzle body;
a first supply line introducing a first molten resin to said first supply port;
a first stop valve being provided within the first supply line;
a second supply line introducing a second molten resin to said second supply port; and
a second stop valve being provided within the second supply line;
said process comprising the steps of:
introducing the resin for core into the dies through said first supply line and said first passage; and
introducing the resin for skin into the dies through said second supply line and said second passage.

8. A process of sandwich molding according to claim 7, wherein said nozzle body is constituted by a casing and a core built into the casing, said discharge port is formed at the tip end of said casing, said first passage is formed on the center axis of said core, and said second passage is formed between the external surface of said core and the internal surface of said casing.

9. A process of sandwich molding for manufacturing an injection molding product, the surface portion of which is formed from a resin for skin and the interior of which is formed from a resin for core, by use of a nozzle,
said nozzle comprising:
a nozzle body being connected via a discharge port provided at the tip end thereof to the back surface of dies, and having a first supply port and a second supply port, a first passage which connects the first supply port to the discharge port and a second passage which connects the second supply port to the discharge port being formed in the interior of said nozzle body;
a first supply line introducing a first molten resin to said first supply port;
a first stop valve being provided within the first supply line;
a second supply line introducing a second molten resin to said second supply port; and
a second stop valve being provided within the second supply line;
said process comprising the steps of:
introducing the resin for skin into the dies through said first supply line and said first passage; and
introducing the resin for core into the dies through said second supply line and said second passage.

10. A process of sandwich molding according to claim 9, wherein said nozzle body is constituted by a casing and a core built into the casing, said discharge port is formed at the tip end of said casing, said first passage is formed on the center axis of said core, and said second passage is formed between the external surface of said core and the internal surface of said casing.
